(19) United States
(12) Patent Application Publication
(10) Pub. No.: US 2007/0267043 A1
(43) Pub. Date: Nov. 22, 2007

(54) Robot system and method for washing and unclogging procedures of machines under maintenance

(76) Inventor: Hugo Salamanca, Santiago (CL)

Correspondence Address: Hugo Salamanca P., Av. Suecia 84, Oficina 43, Providencia, Santiago, RM, CL

(21) Appl. No.: 11/598,175

(22) Filed: Nov. 13, 2006

Related U.S. Application Data
(60) Provisional application No. 60/734,968, filed on Nov. 10, 2005.

(51) Int. Cl. G06F 19/00; B08B 1/00; B08B 13/00

(52) U.S. Cl. 134/6; 901/2

(57) ABSTRACT

At present, the process of washing and unclogging the machines under maintenance of underground equipment or machinery is carried out manually or using mechanical equipment which means the equipment is stopped for a long time and it is then less available. Due to the above, a robot system and method have been developed for automated washing and unclogging procedures for underground machinery.

The robotic system for washing and unclogging the machines under maintenance is composed mainly of an anthropomorphous robotic manipulator of at least 5 degrees of freedom (1), provided with a set of tools (2) which allows to wash and remove the material from the machine (3), all of the system is mounted on a structure specially designed for the activity (4). The operator indicates the beginning of the activity as well as the key parameters for the development of the activity. Due to the above, most of the problems associated to the safety of the personnel and the decrease of available times are eliminated. An increase in the useful life of the equipment is obtained

### CROSS-REFERENCE TO RELATED APPLICATIONS

This application claims the benefit of provisional patent application Ser. No. 60/734,968 filed 2005 Nov. 10 by the present inventor

### FEDERAL SPONSORED RESEARCH

Not Applicable

### SEQUENCE LISTING OR PROGRAM

Not Applicable

### BACKGROUND

1. Field of Invention

This invention relates to the use of robotic technology in mining industry, specifically in machines for underground ore transportation

2. Prior Art

The exploitation of the mine is the first stage of the ore extraction processes. This exploitation stage could be carried out on a open pit or underground mine and includes a wide range of basic operations such as Drilling and Blasting, Loading and Transportation.

Particularly, in underground exploitation, it is necessary to build access tunnels to reach the mineralized region. The retrieval of the rocks is done through the use of explosives and the ore removal is performed by taking advantage of the weight itself of the ore. Thus, the methods most commonly used are pillars, block caving and sublevel caving, which are used to retrieve the mineral from the ore body. These methods have the technical feasibility to large scale economic production.

In the room and pillar method, as the mineral is removed, rooms are generated inside the mine where pillars are left standing to hold up the rock ceiling. Once the ore has been treated in this room, it is filled with sterile material to avoid the hill from collapsing. In turn, the block caving method consists in the preparation of a block through different levels. The block is weakened at its foundation through the formation of tunnels to support the pillars formed in the different galleries.

Finally, the sublevel caving method is a high cost method based on the same principle as the block caving method, in which parallel galleries are built every 11 meters horizontal and 11 meters vertical, so as to cover the mineralized belt to exploit.

Due to the above, the washing and unclogging process of the machines under maintenance is one of the current procedures for the operation underground mining material movement. Supporting mechanical tools are used.

To carry out this activity presents a high physical demand with accident risk for those people carrying out the task.

Another important aspect is the time this activity takes which means less availability of the equipment leading to great losses of productivity.

The washing and unclogging of machines under maintenance as it is done currently has some disadvantages, such as:
Less availability of the equipment, which means less productivity.
Costs associated to the personnel involving the manual and/or mechanical reposition.
The operators in charge of the manual reposition are subjected to a constant physical demand.

### SUMMARY

A robot system and method have been developed for an automated procedure for washing and unclogging of machines under maintenance.

### DRAWINGS—FIGURES

FIG. 1. General view of a robotic system for washing and unclogging the machines under maintenance.

FIG. 2. General view of a robotic system for washing and unclogging the machines under maintenance.

FIG. 3. Lateral view of the robotic system for washing and unclogging the machines under maintenance

### DRAWINGS—REFERENCE NUMERALS

1. Robotic manipulator

2. Tool

3. Machine

4. Mounting Structure

### DETAILED DESCRIPTION

This invention relates to a new robot system as well as a robotic method for the washing and unclogging processes of machines under maintenance, which are carried out automatically through anthropomorphous robotic arms of at least 5 degrees of freedom, mounted on a structure specially designed for such activity.

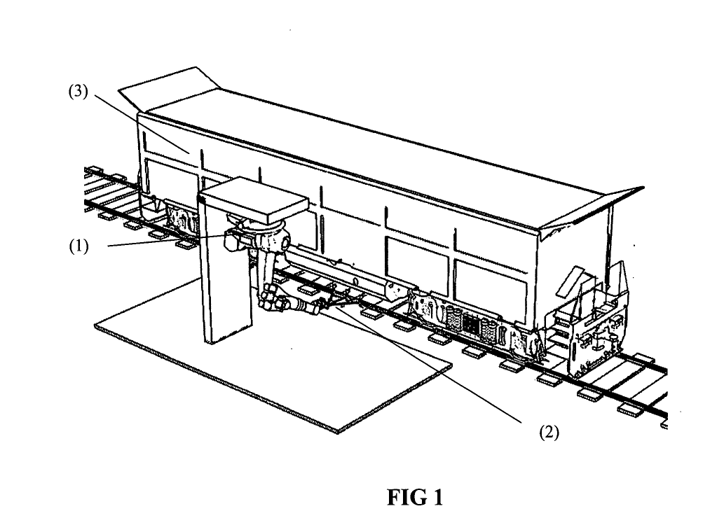

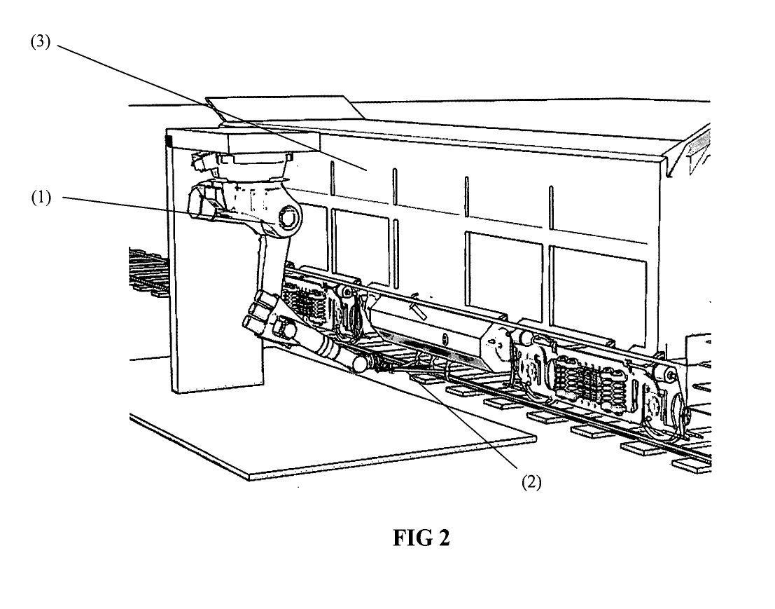

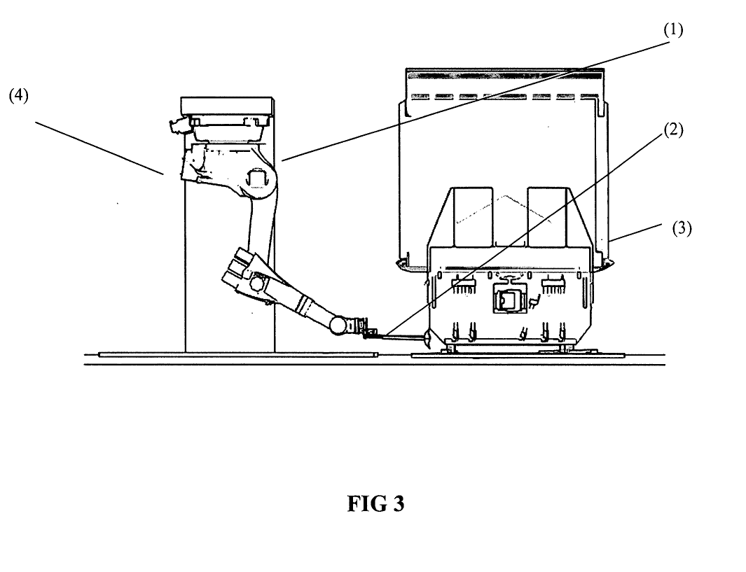

With reference to FIG. 1, FIG. 2, and FIG. 3, the robot system for the washing and unclogging of the machines under maintenance is composed mainly of one anthropomorphous robotic manipulator of at least 5 degrees of freedom (1), provided with a communication, acquisition and control system, and a gripping mechanism to take, manipulate, and release a set of tools (2) which are used to wash and remove material from the machine (3), and the robotic manipulator is mounted on a structure specially designed for this activity (4). The operators indicate the beginning of the activity and the key parameters for developing the activity.

I claim:

1. A robot system for the washing and unclogging of the machines under maintenance, comprising an anthropomorphous robotic arm of at least 5 degrees of freedom, one control, communication and programming unit, one tool adapter, one pneumatic gripper, one pneumatic and/or hydraulic driving system, one electric supply system and one supporting structure wherein the anthropomorphous robotic arm of at least 5 degrees of freedom is provided with a system which allows, in a sequential and programmed way, to take, manipulate and release a set of tools to wash and remove the material from the machinery during the washing and unclogging procedures.

2. A robot system for the washing and unclogging of the machines under maintenance according to claim 1, wherein the system uses a set of tools for washing and unclogging procedures.

3. A robot system for the washing and unclogging of the machines under maintenance according to claim 1, wherein the manipulator is mounted on a fixed and/or mobile structure which is specially designed for washing and unclogging procedures.

4. A robot system for the washing and unclogging of the machines under maintenance according to claim 1, wherein the anthropomorphous robotic manipulator could communicate by itself or through a PLC interface with the control system.

5. A robot system for the washing and unclogging of the machines under maintenance according to claim 1, wherein the anthropomorphous robotic manipulator has the capacity to obtain and interpret the information from installed analogue and/or digital sensors

6. A robot system for the washing and unclogging of the machines under maintenance according to claim 1, wherein the anthropomorphous robotic manipulator has the capacity to generate analogue and/or digital signals to control analogue and/or digital input devices.

7. A robot system for the washing and unclogging of the machines under maintenance according to claim 1, wherein the robotic manipulator has a pneumatic and hydraulic gripping mechanism which allows to take, manipulate and release the different tools within the work volume of the robotic system.

8. A robot system for the washing and unclogging of the machines under maintenance according to claim 1, wherein the anthropomorphous robotic manipulator has an electrical system driven by three-stage induction motors, with vectorial and/or scalar control.

9. A robot system for the washing and unclogging of the machines under maintenance according to claim 1, wherein the system has the capacity to move and manipulate different tools in different paths within the work volume of the robotic system.

10. A robot system for the washing and unclogging of the machines under maintenance according to claim 1, wherein productivity and efficiency in the process of material handling in the mine increases.

11. A robot system for the washing and unclogging of the machines under maintenance according to claim 1, wherein the system may operate automatically, or semi-automatically, and also allows solutions scalability.

12. A robot system for the washing and unclogging of the machines under maintenance according to claim 1, wherein the system could be integrated to washing, unclogging and removal procedures from machinery material not only in processes of material movement during underground extractive operations of different metals such as copper, molybdenum, zinc, lead, etc., but also it could be used for washing and unclogging activities, either individually or in collaboration, in a wide range of other industrial productive processes.

13. A robotic method for the washing and unclogging of the machines under maintenance using the robot System of claim 1 to 12, wherein the anthropomorphous robotic arm of at least 5 degrees of freedom is provided with a system which allows in a sequential and programmed way to take, manipulate and release a set of tools for washing and removing the material from the machinery during washing and unclogging procedures.

14. A method for the washing and unclogging of the machines under maintenance using the robot System of claim 1 to 12, wherein the anthropomorphous robotic manipulator could communicate by itself or through a PLC interface with the control system.

15. A robotic method for the washing and unclogging of the machines under maintenance using the robot System of claim 1 to 12, wherein the anthropomorphous robotic manipulator has the capacity to obtain and interpret the information from installed analogue and/or digital sensors.

16. A robotic method for the washing and unclogging of the machines under maintenance using the robot System of claim 1 to 12, wherein the anthropomorphous robotic manipulator has the capacity to generate analogue and/or digital signals to control analogue and/or digital input devices.

17. A robotic method for the washing and unclogging of the machines under maintenance using the robot System of claim 1 to 12, wherein the system uses a set of tools for washing and unclogging procedures.

18. A robotic method for the washing and unclogging of the machines under maintenance using the robot System of claim 1 to 12, wherein the manipulator is mounted on a fixed and/or mobile structure, which is specially designed for washing and unclogging procedures.

19. A robotic method for the washing and unclogging of the machines under maintenance using the robot System of claim 1 to 12, wherein it uses a pneumatic and hydraulic system to take, manipulate and release the different tools within the work volume of the robotic system.

20. A robotic method for the washing and unclogging of the machines under maintenance using the robot System of claim 1 to 12, wherein the anthropomorphous robotic manipulator has an electrical system driven by three-stage induction motors with vectorial and/or scalar control

21. A robotic method for the washing and unclogging of the machines under maintenance using the robot System of claim 1 to 12, wherein it has the capacity to move and manipulate the different tools used in different paths within the work volume of the robotic system.

22. A robotic method for the washing and unclogging of the machines under maintenance using the robot System of claim 1 to 12, wherein productivity and efficiency of material handling processes in the mine increases.

23. A robotic method for the washing and unclogging of the machines under maintenance using the robot System of claim N^{o} 1 to N^{o} 12, wherein the system may operate automatically, or semi-automatically, and also allows solution scalability.

24. A robotic method for the washing and unclogging of the machines under maintenance using the robot System of claim 1 to 12, wherein the system could be integrated to washing, unclogging and removal procedures from machinery material not only in processes of material movement during underground extractive operations of different metals such as copper, molybdenum, zinc, lead, etc., but also it could be used for washing and unclogging activities, either individually or in collaboration, in a wide range of other industrial productive processes.
